(19) United States
(12) Patent Application Publication
(10) Pub. No.: US 2007/0162386 A1
(43) Pub. Date: Jul. 12, 2007

(54) Relay server, relaying method and payment system

(75) Inventors: Kazunori Suzuki, Tokyo (JP); Taiji Tsuneyoshi, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/705,765

(22) Filed: Feb. 14, 2007

Related U.S. Application Data
(62) Division of application No. 09/899,818, filed on Jul. 9, 2001.

(30) Foreign Application Priority Data
Aug. 22, 2000 (JP) JP-2000-250513

(51) Int. Cl. G07F 19/00; G06Q 40/00; G07B 17/00

(52) U.S. Cl. 705/39; 705/30

(57) ABSTRACT

A relay server to be installed in a payment system which is suitably used in a specially designed terminal having limited communication functions such as a portable telephone. The relay server is provided in the payment system including a user terminal to take payment procedures through a network, a shop server to produce payment information containing amounts to be paid by a user, a payment server to perform payment processing through the network and a wallet server to maintain authentication information of the user and to request the payment server to take payment procedures. The relay server has a redirecting section used to transfer, when receiving procedure request information from the terminal, the information to the shop server and, when receiving the payment information from the shop server having acquired the request information, to transfer the payment information to the wallet server.

### BACKGROUND OF THE INVENTION

1. Field of the Invention

The present invention relates to a relay server adapted to relay, on a network, communication between a terminal device employed by a shopping user using a shop on the network for taking a payment procedure and a wallet server used to take the payment procedure, to a relay method and to a payment system and more particularly to the relay server, relay method and payment system that are well suited to the payment procedures using special terminals such as portable cellular phones and game machines having more limited display capability, storage capacity and Web browser function when compared with information processing device such as general purpose personal computers.

2. Description of the Related Art

As a settlement system that can be used in a conventional payment system in which safety of payment has been improved in electronic commerce (hereinafter referred simply to as “e-commerce”) on a network such as the Internet, a system using a so-called SET (Secure Electronic Transaction) is known.

A wallet server used in the SET settlement system is disclosed in U.S. Ser. No. 09/592,574 and a POS (Point-Of-Sales) server also used in the SET settlement system is disclosed in U.S. Ser. No. 09/609,814, both of which has been applied by the applicant (transferee) of the present invention.

In such the SET, a wallet software functioning as a visual wallet adapted to manage authentication information including a credit number (hereinafter referred simply to as a “card number”), account number of a financial institution or a like is executed by a user terminal such as the personal computer. At this point, when payment information including information about amounts to be paid and the authentication information is supplied from a shop server to be used by a shop on the network to the user terminal, a request is transmitted by the wallet software through the shop server to a payment gateway (hereinafter referred to as a “payment GW”). The payment GW, when receiving the payment request, feeds information about the card number or account number of users to a settlement host installed at each of the credit companies or financial institutions designated by the authentication information. The settlement host executes the processing of a credit settlement or the processing of payment of amounts to be paid from users' bank account.

However, the wallet software described above is generally large in size and different in its installing procedures depending on conditions of the user terminal such as a version of an OS and Web browser, thus requiring a complicated program setting. Moreover, it is difficult to acquire the authentication from a registration authority. Therefore, it is not easy for general users to operate the wallet software by using their own terminals.

To solve such the inconvenience occurring in the use of the wallet software, a method using a Server Wallet is employed. In using this Server Wallet method, the wallet software is executed by a wallet server being another device from the user terminal. The user can use the wallet software installed in the server through the network by using the Web browser.

In the Server Wallet method described above, a program used to carry out communication with the wallet software on the wallet server is executed by the user terminal, as an extended program of the Web browser of the user terminal, that is, as plug-in software. By using the plug-in software, the payment information that the user terminal has received from the shop server is transferred from the user terminal to the wallet server. Thereafter, based on the transferred payment information and on the authentication information held by the wallet server, payment procedures are taken between the wallet server and the settlement institution.

Moreover, at a time of the authentication of the user by a CA (Certificate Authority), the authentication information transmitted to the user terminal from the CA is transferred to the wallet server by the plug-in software. The wallet server stores the authentication information transferred from the user terminal to its server system.

In recent years, specially designed terminals such as portable cellular phones having functions to receive and transmit E-mails and functions that can be implemented by a Web browser, in addition to telephone functions, or game machines having functions of being able to be connected to the Internet or functions that are implemented by the Web browser, can be connected to the Internet. In such the specially designed terminals, since such the terminals have a limited capacity and limited functions to be implemented by the Web browser due to their limitation in designing, it is impossible to execute the plug-in software described above.

Therefore, since, if such the specially designed terminals are used in the e-commerce, the authentication information given by the CA and the payment information given by the shop server cannot be redirected to the wallet server, it is impossible to apply the Server Wallet method. To solve this problem, when these specially designed terminals are used, a conventionally known an SSL (Secure Sockets Layer) method to perform safe electronic settlement is employed. In the above SSL method, encrypting processing is performed on, for example, a card number and the payment procedures are taken by transmitting and receiving encrypted information.

However, in the payment system using the SSL method, there are some cases where the shop server has not been authenticated by the registration authority at a time of the payment procedures. At this point, even if the shop commits so-called “spoofing”, it is not easy to judge whether the spoofing has been committed or not.

Moreover, in the payment procedure using the SSL method, as described above, when the information is transmitted from the user terminal to the shop server, though the predetermined encrypting processing is performed on the information, the shop having received such encrypted information, when taking the payment procedure, has a chance of getting personal information such as information about the credit number and/or a PIN (a personal identification number) of the user. Therefore, there is a fear that the personal information is illegally used by the shop and there have been room for improvement in the e-commerce from the viewpoint of safety.

### SUMMARY OF THE INVENTION

In view of the above, it is an object of the present invention to provide a relay server, a relay method and a payment system that enable payment procedures based on the Server Wallet method by using a specially designed terminal having limited information display capabilities, limited storage capacities and limited functions of Web browsers. It is another object of the present invention to provide the relay server, relay method and payment system that can serve to improve safety of transactions using such specially designed terminals.

According to a first aspect of the present invention, there is provided a relay server to be installed in a payment system made up of a user terminal being able to be connected to a network and used to take a payment procedure for a transaction on the network between a shop and a user using the shop, a shop server connected to the network and used to produce payment information including amounts to be paid by the user in the transaction, a payment server connected to the network and used to perform payment processing for the transaction between the user and the shop and a wallet server connected to the network and having authentication information of the user required for the payment processing to be performed by the payment server and making a request of the payment server through the shop for the payment processing,

wherein the relay server comprises a redirecting section which transfers, when having received procedure requesting information to prompt the shop to take the payment procedure from the user terminal, the procedure requesting information to the shop server and, when having received the payment information from the shop server having acquired the procedure requesting information, transfers the payment information to the wallet server.

In the foregoing, a preferable mode is one wherein the user terminal employed in the payment system has no function of transferring the payment information to the wallet server.

Also, a preferable mode is one wherein the user terminal is able to carry out direct communication with the shop server except a direct receipt of the payment information from the shop server.

Also, a preferable mode is one that wherein includes a contents converting unit being operated, at a time of taking the payment procedure, when the relay server has received information for the payment procedure that had been transmitted from the wallet server toward the user terminal, to select a predetermined information item out of the information for the payment procedures, based on receiving capability of the user terminal, to produce summarized, information using the selected information item and to transmit the summarized information to the user terminal.

Also, a preferable mode is one wherein the information, having been transmitted from the wallet server to the user terminal, is confirming information used for the user to confirm details of the transaction based on the payment information transmitted from the shop server to the wallet server and the predetermined item of the confirming information contains at least amounts to be paid out of the payment information.

Also, a preferable mode is one wherein the summarized information is generated by the contents converting section in accordance with a template in which insertion of the predetermined information item is set in advance and the predetermined item is placed in a predetermined position in the template.

Also, a preferable mode is one wherein the confirming information contains an identifier used to identify the payment procedure and the predetermined information item of the template contains the identifier.

Also, a preferable mode is one that wherein includes a first communicating section used to carry out communication with the user terminal through the network, a second communicating section used to carry out communication through the network with each of the shop servers, settlement institutions, the wallet servers and registration authorities and a control section used to control the communication with each of the first and second communicating sections.

Also, a preferable mode is one wherein the payment server in the payment system, when the payment procedure has terminated, transmits result information showing termination of the payment processing through the wallet server toward the user terminal.

Also, a preferable mode is one wherein, when the time required from when the relay server has received a response for the confirming information from the user terminal to when the relay server has received the result information through the wallet server from the payment server exceeds a predetermined period of time, communicating information used to continue communication between the relay server and the user terminal is exchanged with the user terminal until time of receipt of the result information.

Also, a preferable mode is one wherein the communicating information used to continue communication with the user terminal is information to be transmitted from the relay server to the user terminal which contains information enabling the user to make an inquiry about a progress of the payment processing and information showing the inquiry made, of the relay server, by the user having obtained the information.

Also, a preferable mode is one wherein the payment system has a registration authority to produce the authentication information of the user and, when the relay server has received the authentication information from the registration authority, the redirecting section is operated to transfer the authentication information fed from the registration authority to the wallet server.

Also, a preferable mode is one wherein the information out of which the predetermined item is to be selected by the content converting section is information that the registration authority transmits through the relay server toward the user terminal to produce the authentication information.

Also, a preferable mode is one wherein the payment system is provided with a plurality of the wallet servers, and the information out of which the predetermined item is to be selected by the contents converting section is information used by the user to select the wallet server for the payment out of the plurality of the wallet servers.

According to a second aspect of the present invention, there is provided a method for relaying communication between a user terminal and a wallet server which is employed in a payment system made up of a user terminal being able to be connected to a network and used to take a payment procedure for a transaction on the network between a shop and a user using the shop, a shop server connected to the network and used to produce payment information including amounts to be paid by the user in the transaction, a payment server connected to the network and used to perform payment processing for the transaction between the user and the shop and a wallet server connected to the network and having authentication information of the user required for the payment processing to be performed by the payment server and making a request of the payment server through the shop for the payment processing, and

wherein the method for relaying comprises a step of transferring the payment information transmitted from the shop server to the wallet server and a step of transferring payment processing request transmitted from the user terminal to make a request of the payment server for the payment processing to the wallet server.

According to a third aspect of the present invention, there is provided a payment system including:

a user terminal being able to be connected to a network and used to take a payment procedure for a transaction on the network between a shop and a user using the shop;

a shop server connected to the network and used to produce payment information including amounts to be paid by the user in the transaction;

a payment server connected to the network and used to perform payment processing for the transaction between the user and the shop;

a wallet server connected to the network and having authentication information of the user required for the payment processing to be performed by the payment server and making a request of the payment server through the shop for the payment processing; and

a redirecting section used to transfer, when the payment information is received from the shop server, the payment information to the wallet server and, when a payment processing request to make a request of the payment server for the payment processing is received from the user terminal, the request to the wallet server.

### BRIEF DESCRIPTION OF THE DRAWINGS

The above and other objects, advantages and features of the present invention will be more apparent from the following description taken in conjunction with the accompanying drawings in which:

FIG. 1 is a schematic block of configurations of an electronic commerce system containing the payment system of the present invention;

FIG. 2 is a schematic block diagram showing detailed configurations of a relay server constituting the e-commerce system of the embodiment of the present invention;

FIG. 3 is a diagram showing one procedure of payment in the e-commerce system of the embodiment of the present invention;

FIG. 4 is a diagram showing the other procedure of payment in the e-commerce system of the embodiment of the present invention;

FIG. 5 is a diagram explaining converting operations of contents by the relay server constituting the e-commerce system of the embodiment of the present invention;

FIG. 6 is a diagram explaining operations to maintain session by the relay server constituting the e-commerce system of the embodiment of the present invention; and

FIG. 7 is a diagram explaining operations of selecting a wallet server by the relay server constituting the e-commerce system of the embodiment of the present invention.

### DESCRIPTION OF THE PREFERRED EMBODIMENTS

Best modes of carrying out the present invention will be described in further detail using various embodiments with reference to the accompanying drawings.

### Embodiment

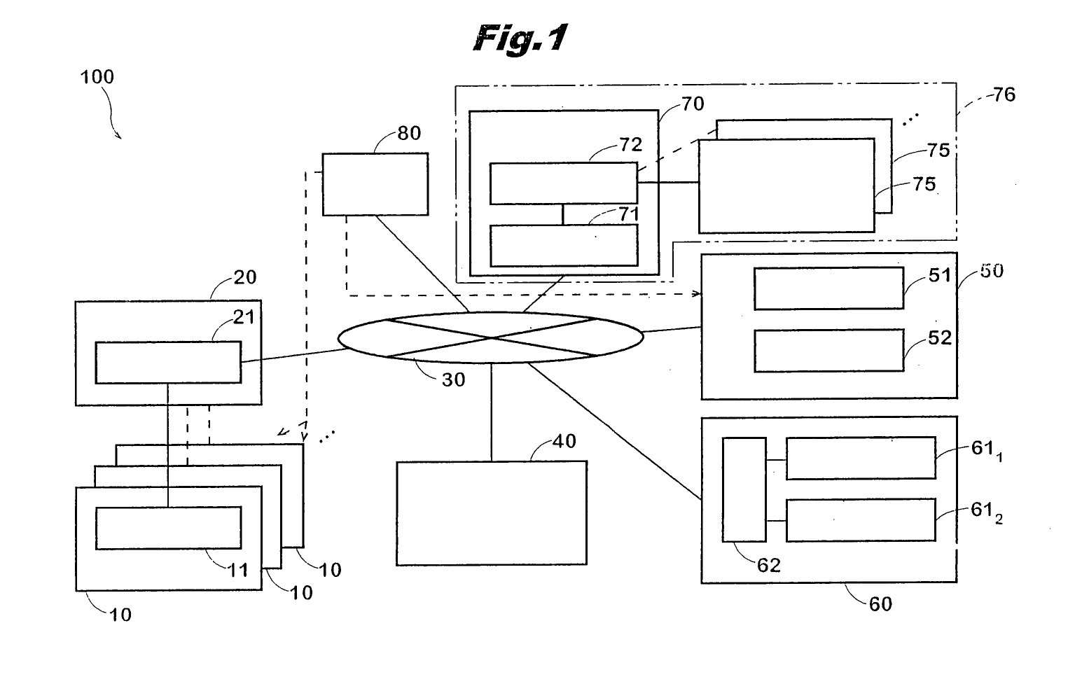

In an embodiment of the present invention, a Server Wallet method using a conventionally known SET (Secure Electronic Transaction) is applied to a payment procedure in e-commerce on a network. FIG. 1 is a schematic block of configurations of the e-commerce system containing the payment system of the present invention. The e-commerce system 100, as shown in FIG. 1, includes a user terminal 10 used in the payment procedures for shopping taken by a shopping user using a shop on a network 30 and a portable terminal gateway (hereinafter referred to as a portable terminal GW) 20 used to connect the user terminal 10 to the network 30. In the example shown in FIG. 1, the Internet is used as the network 30. Moreover, the e-commerce system 100 includes a shop server 50 connected to the network 30 and used to take settlement procedures, a wallet server 60 connected to the network having an electronic wallet storing personal information including the authentication information of each of the users required for the settlement procedures and used to the settlement procedures using the wallet in accordance with an instruction of a user, a settlement host 75 used to perform procedures for payment of amounts to be paid from the user's bank account, in accordance with an instruction of the wallet server 60, a payment gateway 70 connected to the network and used to connect the settlement host 75 to the network 30 and a Certificate Authority (CA) 80 used to perform authentication of users, shops and the payment gateway 70. In the e-commerce system 100, the payment gateway 70 and the settlement host 75 make up a payment server 76 used to perform the payment processing. Moreover, the e-commerce system 100 is provided with a relay server 40 used to relay each payment information to be exchanged between the user terminal 10 and the wallet server 60. The relay server 40 receives a request for payment processing which notifies the shop that the user wants the payment to be made through the settlement institution from the user terminal 10 and transfers the received request for the payment processing to the shop server 50, as described later. Further, the relay server 40 receives payment information including amounts to be paid by the user from the shop server 50 having received the request for the payment processing and transfers the payment information to the wallet server 60.

The user terminal 10 is provided with a Web browser 11 to use a Web service such as browsing of a home page on the Internet. As the user terminal 10, for example, a portable cellular phone and a game machine provided with functions of connecting the portable cellular phone or the game machine to the network 30 through the portable terminal GW 20 and/or with functions of communication using the Web browser machine may be employed as well. These specially designed terminals have more limited display capabilities, storage capacities or the Web browser functions, when compared with information processing device such as general-purpose personal computers.

The portable terminal GW 20 has a protocol converting section 21 used to convert a communication protocol between the communication network for the user terminal 10 and the network 30.

The shop server 50 has a HTTP (Hyper Text Transfer Protocol) server 51 used to connect the shop server 50 to the network and a payment processing section 52 used to produce the payment information including amounts to be paid by the user. The payment processing section 52 performs a function as a well-known POS (Point-Of-Sales) that has been used to perform procedures for electronic settlement of the shop and is provided on the shop server 50 as an extended program of the HTTP server 51, that is, a so-called plug-in software.

The wallet server 60 is provided with personal wallets 61, and 622 which are well-known electronic wallets installed for each of users and with a control section 62 used to control the requests for the payment processing including requests for login processing to the wallet server 60 and for the settlement for each of the users to the settlement host 75.

The payment gateway 70 is provided with a request analyzing section 71 used to analyze the payment requests transferred from the wallet server 60, that is, to decode information showing the payment requests and to select the settlement host 75 to be employed for the payment processing and a payment instructing section 72 used to notify the settlement host 75 based on the analysis result from the request analyzing section 71 of contents of the payment processing request. The payment gateway 70 performs a conversion of protocols applied between the communication network for the settlement institutions and the network 30. The settlement host 75, as described above, is installed for each of the settlement institutions such as financial institutions or credit card companies and, in response to the payment requests notified through the payment gateway 70 by the wallet server 60, executes the payment processing including, for example, processing of payment by a credit card and of payment of amounts to be paid from the user's bank account and then transmits the results of the processing to the payment gateway 70.

The CA 80 performs authentication of the user, shop and payment gateway 70 through the network 30 and issues the authentication electronic certificate showing information about the authentication result. For example, when the authentication of the user is performed, personal information about an account number, card number and its expiration date of a user is provided to the CA 80 through the relay server 40 from the user terminal 10. The CA 80 creates the authentication information of the user based on the supplied personal information and feeds the authentication information through the relay server 40 to the wallet server 60.

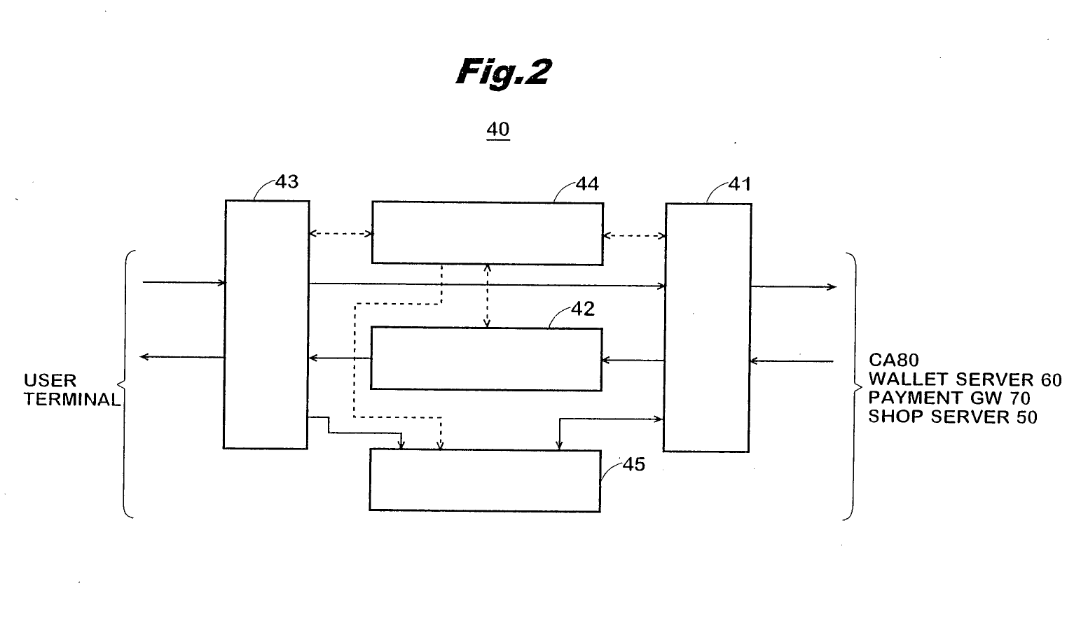

The relay server 40, as shown in FIG. 2, includes a Web client 41 used to make a request of the shop server 50 for information for the payment procedures, a wallet server 60 or a like, in response to an instruction from the user terminal 10, a contents producing section 42 used to summarize the information obtained from the Web client 41, that is, contents such as HTML (Hyper Text Markup Language) documents and image files depending on receiving capability of the user terminal 10 and to produce the summarized contents making up the summarized information, an HTTP server 43 used to supply the summarized contents produced by the contents producing section 42 to the user terminal 10, a control section (connection maintaining section) 44 used to control communication and a redirecting section 45 used to transfer information exchanged among the user terminal 10, a shop server 50, a wallet server 60 and a payment GW 70. In the relay server 40, the HTTP server 43 serves as a first communication section and the Web client 41 as a second communication section.

Ports are assigned, in accordance with the TCP/IP (Transmission Control Protocol/Internet Protocol) protocol, to each of the Web client 41 and the HTTP server 43 in the relay server 40 and the information fed from the network 30 is distributed, corresponding to the port number, to each of the Web client 41 and HTTP server 43.

In the e-commerce system of the present invention, prior to the execution of the payment using the wallet server 60, in accordance with the SET, the user acquires the authentication from the CA 80. When the authentication electronic certificate is issued by the CA 80, as described above, the certificate is stored to the personal wallet of the user (for example, the personal wallet 61₁).

(a) Relay operations of the e-commerce system of the embodiment will be described below.

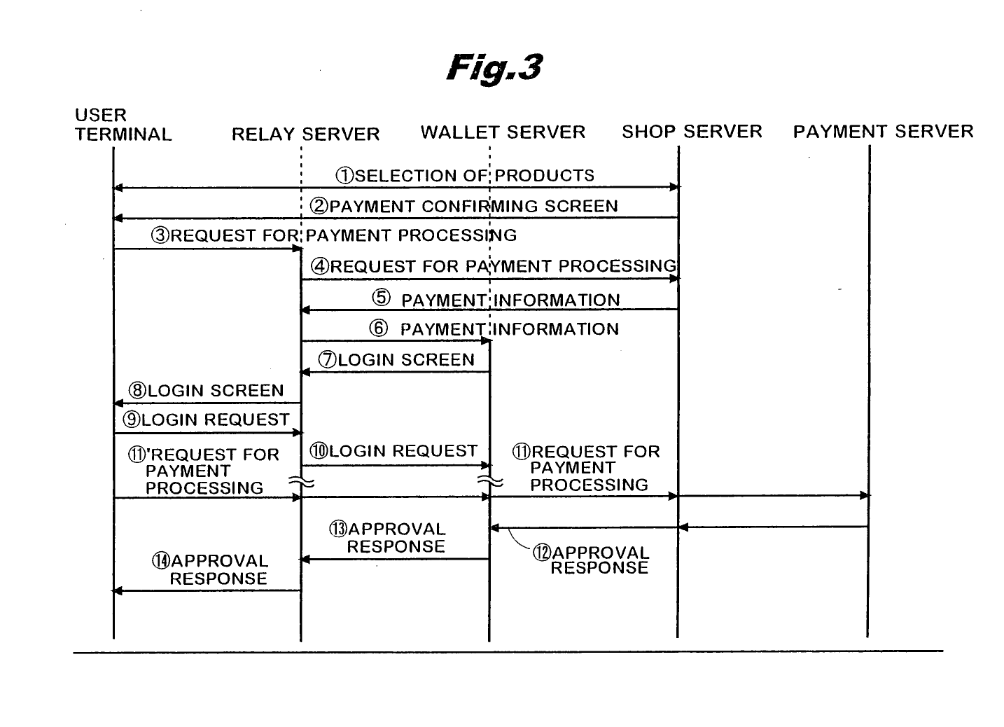

FIG. 3 is a diagram showing one procedure of payment in the e-commerce system of the embodiment of the present invention. By referring to FIG. 3, operations of the relay server 40 in the e-commerce system will be described.

The shopping user browses information provided by the HTTP server 51 in the shop server 50 by operating the user terminal 10 and by using the Web browser and performs predetermined selection processing for every product to be purchased (see \textcircled{1} in FIG. 3). In the selection processing, the user terminal 10 and the shop server 50 carry out direct communication with each other through the network 30, for example, whenever a product is selected by the user, information required for the payment is transmitted from the shop server 50. The user, in stead of performing the selection processing for every product, may select provisionally a desired product by browsing the product information. At this point, the information about each product provisionally selected is sequentially held by the HTTP server 51 in the shop server 50 and then, in accordance with an instruction from the user, an information file showing a list of the product group provisionally selected is supplied from the shop server 50 to the user terminal 10.

After the user has terminated the selection of the product, the HTTP server 51 in the shop server 50 feeds a file used to display a list of the products or a file used to display a screen to confirm the payment to the user terminal 10 (see \textcircled{2} in FIG. 3).

In a program contained in the file, a button is defined which is used to make a request for a final payment, in addition to the information to display the list of purchased products and a total payment amount, that is, the button used for the user to prompt the shop server 50 to take the payment procedures. This button is associated with an address (URL: Uniform Resource Locator) of the relay server 40 and, when the user designates this button, the information showing the request for the payment procedure, that is, the payment processing request, is transmitted to the relay server 40 (see \textcircled{3} in FIG. 3). Thereafter, the request for the payment processing is redirected to by the redirecting section 45 in the relay server 40 the HTTP server 51 in the shop server 50 (see \textcircled{4} in FIG. 3).

When the shop server 50 receives the above payment processing request from the HTTP server 51, in response to the payment processing request, the payment processing section 52 produces the payment information containing amounts to be paid by the user. The payment information is transmitted to the relay server 40 through the HTTP server 51 (see \textcircled{5} in FIG. 3).

The relay server 40, when receiving the payment information, transfers, using the redirecting section 45, the payment information, to the wallet server 60 (see \textcircled{6} in FIG. 3). Moreover, the payment information may be automatically transferred to the wallet server 60, by setting, in advance, the URL of the wallet server 60 that can be used by the user and in accordance with the URL.

The control section 62 in the wallet server 60, when receiving the payment information from the relay server 40, in order to make a request asking that the user logs in to the wallet server 60, transmits data required for the user terminal 10 to display a login screen to the relay server 40 (see \textcircled{7} in FIG. 3). Thereafter, the data is fed by the relay server 40 to the user terminal 10 (see \textcircled{8} in FIG. 3).

The user terminal 10, when receiving the above data on the login screen, causes the login screen to be displayed based on the data and prompts the user to input, for example, the user's name and password. When the user has input the user's name and password, the user terminal 10, transmits the input information as the login request to the relay server 40 (see \textcircled{9} in FIG. 3). Then, the login request is fed from the relay server 40 to the control section in the wallet server 60 (see \textcircled{10}in FIG. 3).

When the login request has been judged by the control section 62 of the wallet server 60 to be an authorized one and the login of the user terminal 10 to the wallet server 60 is allowed, communication between the user terminal 10 and the wallet server 60 is carried out through the relay server 40 to determine conditions including types of credit cards used for the settlement and payment methods. In the communication, confirming information used to confirm the payment condition with the user is transmitted from the wallet server 60 through the relay server 40 to the user terminal 10. The user terminal 10 having received the confirming information transmits the request for payment processing showing a final approval of the payment condition to the wallet server 60 (see \textcircled{11}′ in FIG. 3) through the relay server 40. When the payment condition is determined, the control section 62 in the wallet server 60 feeds a certificate of a user stored in advance in the personal wallet (for example, personal wallet 61₁) who has logged in and the payment information fed from the relay server 40, as the payment request, to the payment GW 70 (see \textcircled{11} in FIG. 3) through the shop server 50.

The payment GW 70 checks whether the certificate is an authorized one or not and, if it is the authorized one, instructs the settlement host 75 of a settlement institution corresponding to the payment information to perform the payment processing. The settlement host 75, in accordance with the instruction, executes the payment processing including the payment of amounts to be paid from the bank account of the user and, when this payment processing has terminated properly, notifies the payment GW 70 of the termination. The payment GW 70, in accordance with the notification, transmits result information showing the proper termination of the payment processing, that is, an approval response, to the wallet server 60 through the shop server 50 (see \textcircled{12} in FIG. 3). The wallet server 60 transmits the received approval response to the relay server 40 (see \textcircled{13} in FIG. 3). The approval response, when the relay server 40 has undergone the content converting processing described later, is transmitted to the user terminal 10 (see \textcircled{13} in FIG. 3).

The user terminal 10, when receiving the approval response, produces a screen including character strings based on the approval response and showing the proper termination of the payment processing and displays this screen. The user can confirm, by seeing the screen, that the payment processing has terminated.

In the e-commerce system 100, as described above, instead of the direct transmission of the payment information in response to the request for the payment processing fed from the user terminal 10 to the user terminal 10, the payment information is transmitted from the shop server 50 to the relay server 40 and is transferred to the wallet server 60 through the redirecting section 45.

Therefore, according to the e-commerce system 100 of the embodiment, even if such the specially designed terminal having a transmission function as described above is used as the user terminal 10, since the relay server 40, instead of the specially designed terminal, performs the transmission function, it is possible to execute the payment processing using the wallet server 60.

(b) Operations of maintaining connections will be described.

Some of the user terminals 10, in order to reduce communication costs, have a function of chopping a call if there is no transmission and/or receipt of data within a specified period of time. That is, when such the user terminal 10 is used, for example, the payment processing request from many users is concentrated to the payment GW 70 and it takes much time in making a response from the payment GW 70, the call from the user terminal 10 is chopped by the function of chopping.

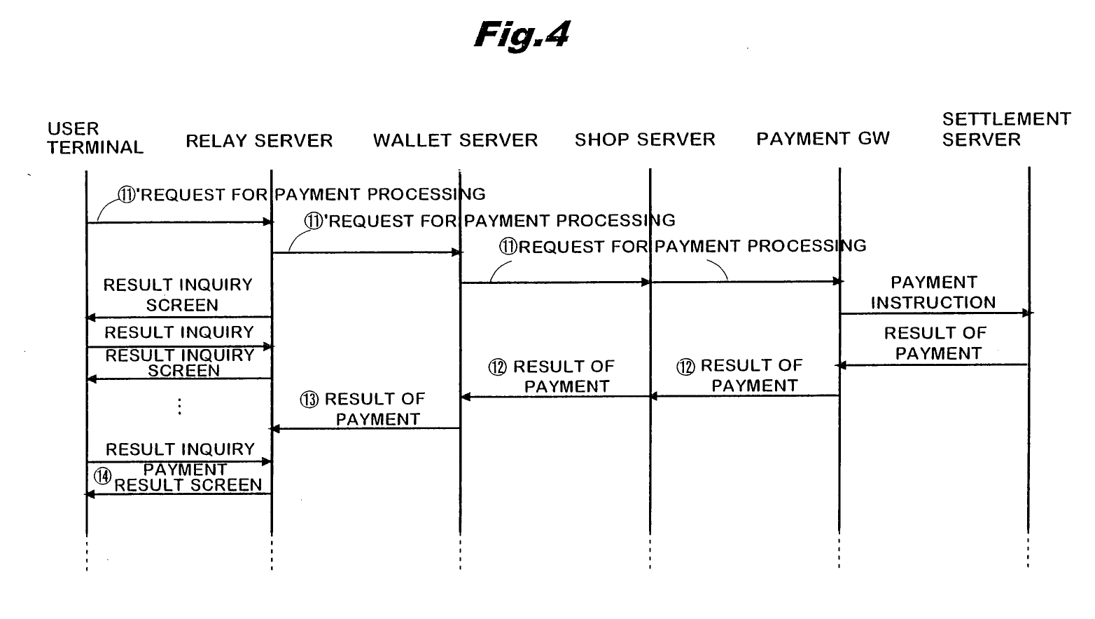

Therefore, in the e-commerce system 100 of the embodiment, in response to instructions of the user, calling between the user terminal 10 and the portable terminal GW 20 is maintained. FIG. 4 is an explanatory diagram explaining maintenance of the call as described above. More particularly, as shown in FIG. 4, after the user terminal 10 has logged in to the wallet server 60, the control section 44 of the relay server 40 transmits the payment processing request from the user terminal 10 to the wallet server 60 (see \textcircled{11}′ in FIG. 4). In response to the payment processing request, the wallet server 60 transmits the payment processing request to the payment GW 70 through the shop server 50 (see \textcircled{11}′ in FIG. 4) and the payment GW 70, in response to the payment processing request, instructs the settlement host 75 to perform settlement of the payment. Then, after the settlement host 75 has terminated the payment processing including the payment of amounts to be paid from a bank of the user, the result of the payment is fed to the relay server 40 through the payment GW 70, shop server 50 and wallet server 60 (see \textcircled{12} and \textcircled{3} in FIG. 4).

If the time required for the relay server 40 to receive the result of the payment from the wallet server 60 after having received the payment processing request from the user terminal 10 exceeds a specified level, the relay server 40 is operated to maintain the call to prevent the call from the user terminal 10 from being chopped. That is, at the same time when the above-described payment procedures are taken, the HTTP server 43 in the relay server 40, in response to instructions from the control section 44, feeds contents showing the progress of the payment procedures to the user terminal 10. The contents can be used as the HTML document to display a screen used to make an inquiry about the payment processing result.

The user, by using the inquiry screen fed from the relay server 40, makes an instruction for inquiring the progress of the payment processing of the user terminal 10. The instruction to be made by the user can be implemented by designating, for example, a button for the inquiry which has been defined, in advance, in the HTML document. When the instruction is input to the user terminal 10 by the user, the Web browser of the user terminal 10 makes a request for contents showing the progress of the payment processing to the HTTP server 43 in the relay server 40 to make the inquiry.

The HTTP server 43 in the relay server 40, when receiving an inquiry from the user terminal 10 and, if not receiving the result of the payment from the wallet server 60, again transmits the HTML document to be used as the inquiry screen to the user terminal 10.

The relay server 40, if it had already received the result of the payment before receiving the inquiry from the user terminal 10, in order to notify the user of the termination of the payment processing, feeds a document used to display the payment result screen, instead of the document of the inquiry screen, to the user terminal 10 (see \textcircled{14} in FIG. 4).

Thus, since the HTML document is fed from the HTTP server 43 in the relay server 40 to the user terminal 10 and a screen to display the document is displayed by the Web browser 11, the user can know the progress of the payment processing.

As described above, since the e-commerce system 100 of the embodiment is so configured that the user terminal 10 can confirm the progress of the payment in response to an instruction from the user, by the confirmation of the progress of the payment for every specified time by the user, the communication between the user terminal 10 and the relay server 4 can be continued and the call between the user terminal 10 and the portable terminal GW 20 can be maintained. As a result, it is possible to prevent the call from the user terminal 10 from being chopped.

Moreover, operations for the Web browser 11 in the user terminal 10 to automatically confirm the payment result at every specified time may be described in the HTML document in which the above button is defined. In this case, since the user does not repeat the described instruction to the user terminal 10 and the Web browser 11 is operated to automatically confirm the payment result at every specified time in accordance with contents in the HTML document, the communication between the user terminal 10 and the relay server 40 can be continued and the call between the user terminal 10 and the portable terminal GW 20 can be maintained.

Moreover, as described above, since the e-commerce system 100 of the embodiment is so configured that, when the request for payment is fed from the user terminal 10, the payment processing is continued between the relay server 40 and the wallet server 60, even if the call from the user terminal 10 is chopped before the relay server 40 obtains the payment result from the payment GW 70, the relay server 40 may continue the payment result in cooperation with the wallet server 60. Thus, even when the call is chopped due to a deterioration of a line state and due to a wrong operation of the user, the payment processing can be still continued between the relay server 40 and the wallet server 60 and, when a new call is issued through the user terminal 10 by the user, the progress of the payment processing can be smoothly confirmed.

Furthermore, for example, when time is required for the processing to be performed by the payment GW 70, even when the call is chopped by the will of the user, by setting the call again after a predetermined time, it is possible to confirm the progress of the payment processing and to reduce communication costs in the user terminal 10.

(c) Production of contents for specially designed terminals will be described below.

Since such the specially designed terminals as the portable telephone and game machines to be used as the user terminal 10 have limited display capabilities, limited storage capacities and limited functions of the installed Web browser, contents such as the HTML document from the wallet server 60 and image files cannot be displayed properly. In some cases, the contents transmitted to the user terminal 10 from the wallet server 60 contain parts that are not required to identify amounts to be paid, products or likes.

In the relay server 40 in the e-commerce system 100, a contents producing section 42, based on contents obtained from the wallet server 60 by a Web client 41, produces contents corresponding to the display capabilities of the user terminal 10, feeds the produced contents to the user terminal 10 using the HTTP server 43.

Items to be limited in the user terminal 10 include the number of characters that can be displayed, shades of gray of images that can be displayed, sizes of contents that can be allowed or a like. The contents producing section 42 in the relay server 40 monitor contents obtained from the wallet server 60 to check whether they are within the limited level.

If the contents that the Web client 41 has obtained from the wallet server 60 exceed the limited level, the contents producing section 42 produces contents in a predetermined form set in accordance with obtained contents or contents divided in a predetermined size.

For example, if contents are those used to identify products and amounts to be paid such as the confirming information to confirm amounts to be paid with the user, the contents producing section 42, in accordance with the predetermined template, extracts predetermined information such as information about products contained in the obtained contents and amounts to be paid and inserts the extracted information into the template and produces, using this inserted information, contents as the summarized information to the user terminal 10. At this point, the template has been so set as to contain minimum items required for the generation of the summarized information out of contents obtained from the wallet server 60. The template can be set to contents requiring changes of displayed format depending on the level of the change.

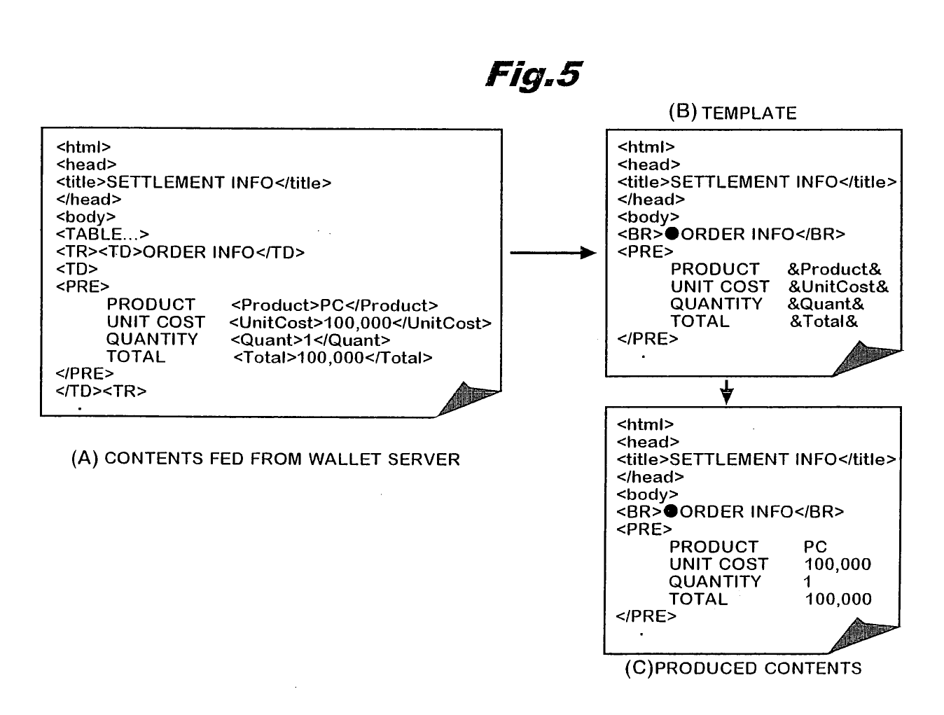

That is, when the HTML contents that the Web client 41 in the relay server 40 contain information except the predetermined information, the content producing section 42 extracts, in accordance with the template, the predetermined information from the HTML contents and inserts the extracted information into the template. This causes the contents to be produced as the summarized information. FIG. 5 is an example of production of the summarized information using the template. Here, let it be assumed that the HTML contents that the Web client 41 has obtained is the confirming information.

In contents showing the confirming information, as shown in FIG. 5 (A), for example, a personal computer being an entity of a product item is bracketed by tags made up of “<Product>” and “</Product>”. At this point, as shown in FIG. 5 (B), in the template, when the item showing the summarized information contains the above product item, the description (“&Product&”) expressed by bracketing the tag name (“Product”) corresponding to the ┌personal computer┘ is set, in advance, to a predetermined place in the template.

More particularly, in the example shown in FIG. 5 (B), “Product” showing a product, “UnitCost” showing a unit price, “Quant” showing a quantity, “Total” showing a total amount, as the identifier of the information extracted from the contents, that is, as item names of the tag described above, are designated. The contents producing section 42 extracts the entity corresponding to these identifiers from contents shown in FIG. 5(A). The extracted entity is inserted, instead of “&Product&”, “&UnitCost&”, “&Quant&” and “&Total&” in the template. As a result, as shown in FIG. 5 (C), contents are produced as the summarized information. The contents thus produced are fed to the Web browser 11 of the user terminal 10 by the HTTP server 43 of the relay server 40.

Moreover, if the contents produced in accordance with the template exceed the limited level in the user terminal 10 described above, further conversion of the contents is made possible. For example, if a size of the summarized contents produced in accordance with the template exceeds a size that is allowable based on the above limitation, the summarized contents are appropriately divided so that the size is within the allowable level.

Thus, in the e-commerce system 100 of the embodiment, the summarized contents are produced from the contents that the Web client 41 in the relay server 40 in accordance with display capability of the user terminal 10 and this summarized contents are fed to the user terminal 10 and, therefore, when such the specially designed terminal as described above is used as the user terminal 10 and the payment procedures based on the server wallet can be easily executed.

(d) Management of a session is described below.

In the server wallet method, it is necessary to identify communication (session) for every payment procedure between the user terminal 10 and the wallet server 60. To perform the identification, so-called cookie is used. However, when the above-described specially designed terminal is used as the user terminal 10, due to the limitation by the Web browser 11 of the specially designed terminal, the cookie cannot be used.

In the e-commerce system 100, in order to be able to use the cookie in such situations as described, the identification information corresponding to a session ID of the Cookie is embedded in contents. Moreover, the identification information is taken out from the response contents that has been transmitted from the user terminal 10 having received the contents and the cookie information is produced based on the identification information and then the cookie information is fed to the wallet server 60 or a like.

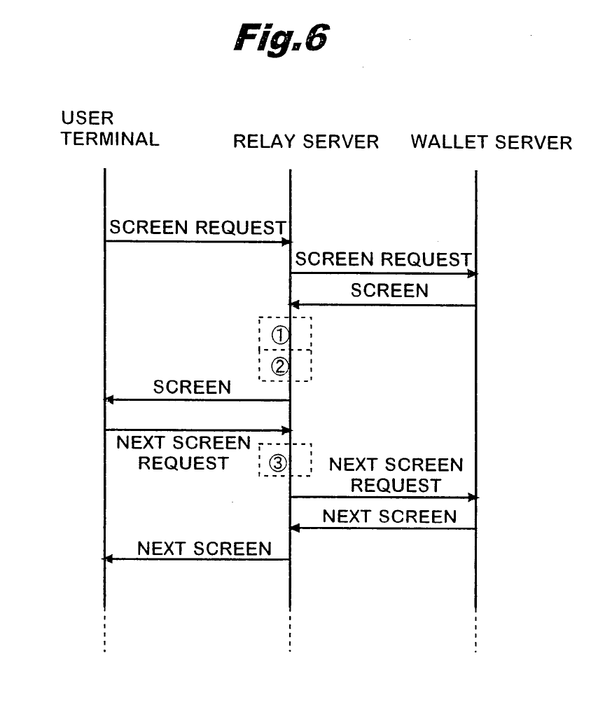

More particularly, as shown in FIG. 6, the relay server 40, at the time of the payment procedure, when, for example, contents on the screen are requested by the user terminal 10, transfers the request to the wallet server 60. The wallet server 60, in response to the request, transmits contents showing the HTML document used to display a screen to the relay server 40. At this point, the cookie is added to the contents from the wallet server 60. The contents producing section 42 in the relay server 40 takes out the session ID from the cookie information (in \textcircled{1} in FIG. 6) and embeds the taken-out session ID in the contents to be transmitted to the user terminal 10, as the session ID (in \textcircled{2} in FIG. 6). A hidden character string bracketed by a predetermined tag that has been set so as not to be displayed on a screen can be used as the identification information. When the identification information is embedded in contents, for example, the insertion of the hidden character string can be set in advance in the template.

When the contents are transmitted from the relay server 40 to the user terminal 10, though a screen corresponding to the contents, that is, contents in which the identification information is embedded, is displayed by the Web browser 11, the hidden character string is not displayed. In the contents, for example, like in the case in which the user makes a request asking that the user terminal 10 displays a next screen, when other contents being linked with the above contents are designated, operations for transmitting the above designated content to the relay server 40 are described in advance in the contents.

The contents showing the request asking the next screen to be transmitted from the user terminal 10 to the relay server 40 contain the hidden character string. The relay server 40, after the contents producing section 42 has returned the hidden character string embedded in the contents from the user terminal 10 to the session ID for the cookie, feeds contents containing the cookie with the session ID to the wallet server 60 (in \textcircled{3} in FIG. 6).

The wallet server 60 recognizes the session by using the cookie added to the next screen request by the relay server 40 and feeds contents of the response in the session, that is, contents of the next screen requested by the user terminal 10 through the relay server 40 to the user terminal 10.

In the e-commerce system 100, since the relay server 40 adds the hidden character string corresponding to the session ID of the cookie to contents to be fed to the user terminal 10 and restores the cookie from the hidden character string of the response contents from the user terminal 10 to the contents and passes on the response contents to the wallet server 60, even when the specially designed terminal that cannot use the cookie is used, the session management by the cookie can be realized.

(e) Selection of the wallet is described below.

The number of the wallet server 60 that can be used from the user terminal 10 is limited to one, that is, the wallet server 60 is mounted for every group made up of each of the settlement institutions or a plurality of settlement institutions. When there is a plurality of settlement institutions that can be used by both the user and shop, a plurality of the wallet server 60 that can be used by one user exists.

In the e-commerce system 100, the user can use selectively such the plurality of wallet server 60. To execute the selection, the relay server 40, when receiving the payment request from the shop server 50, feeds contents used to display the selection screen of the wallet server 60 to the user terminal 10. When the user selects the wallet server 60 by using the selection screen, the selection result is fed from the user terminal 10 to the relay server 40.

In the above payment information to be fed from the shop server 50 in accordance with the payment processing request from the user terminal 10, the wallet server 60 that can be used by the shop server 50 is designated.

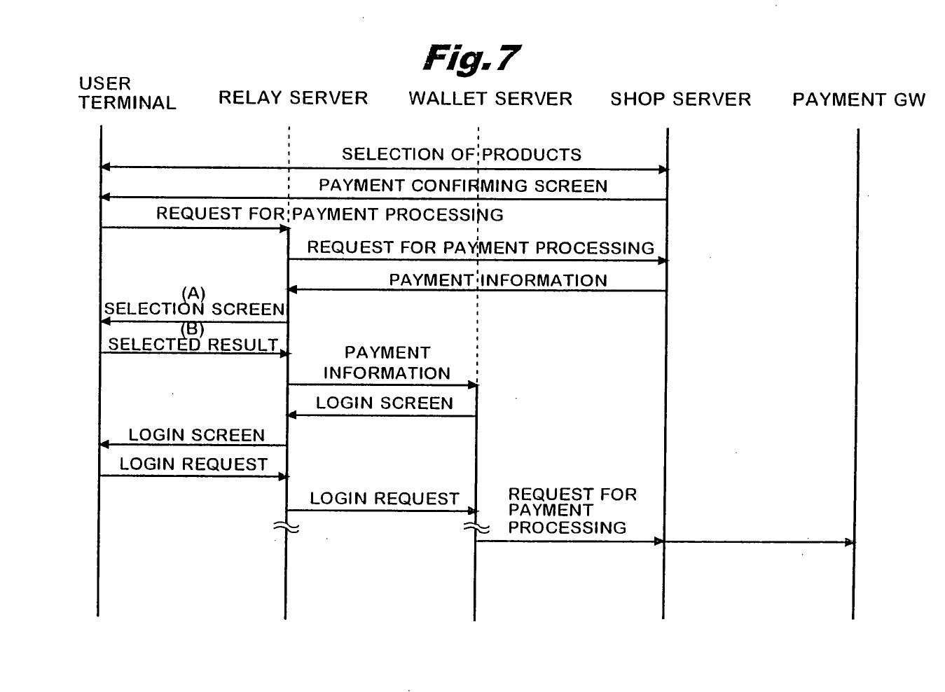

Next, the selection procedures are described in detail below, by referring to FIG. 7. The contents producing section 42 in the relay server 40 produces the HTML contents used to display a screen for selecting the wallet server 60 that can be used from the wallet server 60 designated in the payment information and feeds the contents to the user terminal 10 (in (A) in FIG. 7).

When the contents are fed to the user terminal 10, the Web browser 11 displays the selection screen to cause the user to select the wallet server 60 and feeds information showing the wallet server 60 selected by the user, that is, selected results to the relay server 40 (in (B) in FIG. 7).

The relay server 40, when receiving the selected results, transfers the payment information from the shop server 50 to the selected wallet server 60. Then, after the login processing by the user terminal 10 to the wallet server 60 has been allowed, by the same login procedures as described above, the wallet server 60 sends back the payment processing request to the payment GW 70.

Thus, in the e-commerce system 100, contents used to select the wallet server 60 that can be used by a plurality of wallet servers 60 are transmitted from the relay server 40 to the user terminal 10 and, based on the selected result in contents from the user, the wallet server 60 is selected. Therefore, even when the specially designed terminal having limited communication functions is used as the user terminal 10, the wallet server 60 for the payment procedure can be selectively used.

Moreover, in the e-commerce system 100 of the embodiment, since a desired wallet server 60 out of a plurality of wallet servers 60 can be selected by one relay server 40, which serves to reduce more costs and to improve more maintenance work, when compared with the case in which a plurality of relay servers is provided.

It is thus apparent that the present invention is not limited to the above embodiments but may be changed and modified without departing from the scope and spirit of the invention. For example, the present invention is not limited to relay actions used in the payment procedures, that is, the present invention can be applied to an inquiry about transaction history, acquisition, renewal and deletion of the new certificate, renewal processing of the user information for persona wallets provided by the wallet server, that is, operations for the personal wallet. In the authentication procedures to acquire the new certificate, the relay server 40 is operated in accordance with procedures shown in FIG. 3 and the relay server 40 transmits the authentication information fed from the CA 80 in accordance with the authentication request from the user terminal 10 to the wallet server 60.

As described above, according to the present invention, when the request for the payment processing is made by the user to the settlement institution, the relay server transmits the payment processing request from the user terminal to the shop server and, in response to the payment processing request, the payment information fed from the shop server is transmitted to the wallet server. Therefore, according to the e-commerce system of the present invention, even if such the specially designed terminal having limited display capabilities, limited storage capacities or limited communication functions of the Web browser is used as the user terminal, it is possible to execute the payment processing using the wallet server.

1-5. (canceled)

16. A payment system comprising:
a user terminal able to be connected to a network and used to take a payment procedure for a transaction on said network between a shop and a user of said user terminal;
a shop server connected to said network and used to produce payment information including an amount to be paid by said user in said transaction;
a payment server connected to said network and used to perform payment processing for said transaction between said user and said shop;
a wallet server connected to said network and having authentication information of said user required for said payment processing to be performed by said payment server and making a request of said payment server through said shop for said payment processing; and
a redirecting section used to receive said payment information from said shop server and transfer said payment information to said wallet server, and to receive from said user terminal a payment processing request to make a request of said payment server for said payment processing and to transfer said request for payment processing to said wallet server.

17. The payment system according to claim 16, wherein said user terminal comprises a portable cellular phone having a web browser.
